(19) United States
(12) Patent Application Publication
(10) Pub. No.: US 2024/0253271 A1
(43) Pub. Date: Aug. 1, 2024

(54) SYSTEM AND METHOD FOR SQUARING INGOT

(71) Applicant: TCL ZHONGHUAN RENEWABLE ENERGY TECHNOLOGY CO., LTD, Tianjin (CN)

(72) Inventors: Xiaopeng WANG, Tianjin (CN); Zhihui LIANG, Tianjin (CN); Xizhen LI, Tianjin (CN); Yiqiang GONG, Tianjin (CN); Meng WANG, Tianjin (CN); Yan SHI, Tianjin (CN); Shusheng YANG, Tianjin (CN); Yanhui ZHAO, Tianjin (CN); Shun CHANG, Tianjin (CN); Xuelong LIN, Tianjin (CN); Zhijian LI, Tianjin (CN); Wei ZHAO, Tianjin (CN); Guangyu WANG, Tianjin (CN); Kun YIN, Tianjin (CN)

(73) Assignee: TCL ZHONGHUAN RENEWABLE ENERGY TECHNOLOGY CO., LTD, Tianjin (CN)

(21) Appl. No.: 18/040,141

(22) PCT Filed: Nov. 25, 2022
(86) PCT No.: PCT/CN2022/134286

§ 371 Date: Jan. 31, 2023

(30) Foreign Application Priority Data
Jan. 26, 2022 (CN) 202210094054.3

(51) Int. Cl. B28D 5/00

(52) U.S. Cl. CPC B28D 5/0082; B28D 5/0076

(57) ABSTRACT

A system and a method for squaring a ingot are provided, the system for squaring a ingot, including: a squaring chamber configured to remove cut edges of the ingot; and a movement stage disposed at one side of the squaring chamber in a first direction, wherein the movement stage is provided with a loading mechanism and a unloading mechanism, the loading mechanism and the unloading mechanism are respectively arranged on two sides of the movement stage opposite to each other in a second direction different from the first direction, and while the unloading mechanism collects the cut edges and removes the ingot after removal of the cut edges, the loading mechanism is configured to transport another ingot to be squared to the squaring chamber.

### CROSS REFERENCE TO RELATED APPLICATIONS

This application claims the benefit of priority to Chinese Patent Application No. 202210094054.3 filed on Jan. 26, 2022, the content of which is incorporated herein by reference in its entirety.

### TECHNICAL FIELD

The present disclosure relates to a monocrystalline silicon bar processing technology, and particularly relates to a system and a method for squaring an ingot.

### BACKGROUND

In a process for squaring an ingot, a conventional apparatus operates by using a same sliding track, and loading and unloading processes are performed on a same side. That is, the loading of the ingot before squaring and the unloading of the ingot after squaring are both performed by using a same manipulator. The manipulator cannot perform a turnover during the loading process while gripping during the unloading process, so that work time for the loading and the unloading processes is wasted, and the loading and the unloading processes cannot be smoothly succeeded. Therefore, processing efficiency is low and apparatus activation is low. At the same time, due to unreasonable design for a structure of the equipment, it is easy to bump between cut edges during the unloading process for the squared cut edges, and it is also easy to bump or break during the unloading process of the ingot.

### SUMMARY

In some embodiments of the present disclosure, a system for squaring an ingot, includes: a squaring chamber configured to cut edges from the ingot; and a movement stage disposed at one side of the squaring chamber in a first direction, wherein the movement stage is provided with a loading mechanism and a unloading mechanism, the loading mechanism and the unloading mechanism are respectively arranged on two opposite sides of the movement stage in a second direction different from the first direction, and the loading mechanism is configured to transport an ingot to be squared to the squaring chamber while the unloading mechanism collects cut edges and removes the ingot after the edges are cut.

In an embodiment of the present disclosure, the squaring chamber includes a hold mechanism suspended in the first direction for holding the ingot, and the hold mechanism includes main hold shafts and auxiliary hold shafts;
the main hold shafts are configured to hold end surfaces of the ingot;
the auxiliary hold shafts are configured to hold opposite end surfaces of the cut edges of the ingot; and
the main hold shafts and the auxiliary hold shafts are configured to move together to the movement stage in the first direction a hold mechanism suspended in the first direction for holding the ingot, and the hold mechanism includes main hold shafts and auxiliary hold shafts; the main hold shafts are configured to hold end surfaces of the ingot;
the auxiliary hold shafts are configured to hold opposite end surfaces of the cut edges of the ingot; and
the main hold shafts and the auxiliary hold shafts are configured to move together to the movement stage in the first direction.

In an embodiment of the present disclosure, the movement stage includes a slide stage disposed outside the squaring chamber, the loading mechanism and the unloading mechanism are both disposed parallel to the length of the squaring chamber and perpendicular to a length of the slide stage, and the loading mechanism and the unloading mechanism are separately slidably disposed along the length of the slide stage.

In an embodiment of the present disclosure, the loading mechanism includes:
a loading stage secured at an end portion of the movement stage in the second direction; and
a preparation stage disposed close to the squaring chamber and cooperated with the loading stage, wherein the loading stage and the preparation stage are provided with loading tracks
arranged coaxially;
the preparation stage are further provided with two clamping members for grasping the ingot; and
a height of the loading track of the preparation stage is constant and higher than a height of an original position of the loading track of the loading stage, and the loading stage is configured to move up and down in a vertical direction, so that the ingot disposed on the loading stage moves onto the preparation stage along the loading track the loading mechanism includes:
a loading stage secured at an end portion of the movement stage in the second direction; and
a preparation stage disposed close to the squaring chamber and cooperated with the loading stage,
wherein the loading stage and the preparation stage are provided with loading tracks arranged coaxially;
the preparation stage is further provided with two clamping members for grasping the ingot; and
a height of the loading track of the preparation stage is constant and higher than a height of an original position of the loading track of the loading stage, and the loading stage is configured to move up and down in a vertical direction, so that the ingot disposed on the loading stage moves onto the preparation stage along the loading track.

In an embodiment of the present disclosure, each of the clamping members includes two jaws disposed opposite to each other in the second direction, each jaw has a C-like shaped inner sidewall, and the loading track of the preparation stage extends in the first direction passing through a clamping area defined by the jaws.

In an embodiment of the present disclosure, the loading track on the preparation stage includes a stopper for positioning the ingot, and the stopper is secured at an end of the loading track on the preparation stage close to the squaring chamber;
one of the clamping members close to the stopper is configured to move in the second direction; and
one of the clamping members away from the stopper is configured to move in the first direction and the second direction the loading track on the preparation stage includes a stopper for positioning the ingot, and the stopper is secured at an end of the loading track on the preparation stage close to the squaring chamber;
one of the clamping members close to the stopper is configured to move in the second direction; and
one of the clamping members away from the stopper is configured to move in the first direction and the second direction.

In an embodiment of the present disclosure, a pull bar is disposed on the one of the clamping members away from the stopper, and the pull bar is driven by the one of the clamping members away from the stopper to pull the ingot to move toward the stopper and to make the ingot being abutted against and secured onto the preparation stage by the stopper, and
the pull bar has an L-shaped configuration, one end of the pull bar is secured to a side surface close the loading stage of the one of the second clamping members away from the stopper, and another end of the pull bar is suspended.

In an embodiment of the present disclosure, the unloading mechanism is disposed at an end portion of the movement stage away from the loading mechanism, the unloading mechanism includes an unloading stage partially secured to the movement stage and a collection box for collecting the cut edges;
the unloading stage is located above the collection box in a third direction different from the first direction and the second direction, and operates independently from the collection box; and
the unloading stage is configured to move up and down in the third direction to receive the ingot without the cut edges and to move the ingot to an unloading turnover stage.

In an embodiment of the present disclosure, the unloading stage is disposed with an unloading track;
both the unloading track and the loading track include a plurality of rubber rollers;
the rubber rollers of the unloading tracks are all horizontally arranged;
the rubber rollers of the loading tracks are all arranged obliquely upward and facing each other; and
an end portion of the unloading track close the squaring chamber is provided with a plurality of sets of baffles for preventing the ingot without the cut edges from shifting, and the baffles are arranged spaced apart from each other in the first direction and are disposed on both sides of the unloading track.

In an embodiment of the present disclosure, the collection box includes two recession grooves, the recession grooves extend in parallel in the first direction and are respectively disposed at two opposite sides of the collection box in the second direction, and a distance between the recession grooves is not greater than a width of the ingot without the cut edges; and
the collection box is configured to move to a location directly below the ingot and outside the squaring chamber cut edge with the two recession grooves symmetrically disposed with respect to a central axis of the ingot before each pair of opposite cut edges falls.

The present disclosure provides method for squaring an ingot by using the system for squaring the ingot as described in any one of the above embodiments, including the steps of:
sequentially cutting respective pairs of opposite cut edges in the squaring chamber, based on a number of the pairs of the opposite cut edges of the ingot, and collecting the pairs of cut edges at a position between the squaring chamber and the movement stage after cutting the respective pairs of the opposite cut edges; and
obtaining the ingot without the cut edges by the unloading mechanism, and at the same time, loading another ingot with cut edges to be removed to the squaring chamber by the loading mechanism.

In an embodiment of the present disclosure, the method further includes: before the loading of another ingot with the cut edges to be removed at a door of the squaring chamber close to the movement stage by the loading mechanism, securing the ingot on the preparation stage of the loading mechanism, wherein the step of securing of the ingot on the preparation stage of the loading mechanism includes:
transporting the ingot onto the preparation stage along the loading tracks from the loading stage of the loading mechanism;
moving the ingot towards one end of the preparation stage close to the squaring chamber by one of the clamping members on the preparation stage close to the loading stage;
making the end surface of the ingot away from the loading stage abut the stopper on the loading track of the preparation stage;
clamping the ingot by all the clamping members; and
moving the ingot by the preparation stage to the door of the squaring chamber close to the slide stage.

In an embodiment of the present disclosure, the clamping of the ingot by the clamping members includes:
suspending the hold mechanism at the position between the squaring chamber and the movement stage, and providing in advance the hold mechanism at both ends of the ingot;
securing the end surfaces of the ingot by the main hold shaft;
securing the end surfaces of any pair of opposite cut edges of the ingot by the auxiliary hold shaft;
moving the ingot by the hold mechanism passing through a space between the clamping members and into the squaring chamber to be cut; and
moving the preparation stage to retract opened clamping members.

In an embodiment of the present disclosure, the collecting of the cut edges includes: moving the collection box from a position below the unloading stage to a position
directly below the ingot taken out of the squaring chamber;
releasing the auxiliary hold shafts and dropping the opposite cut edges to fall into the recession grooves of the collection box respectively corresponding to the cut edges;
repeating the above steps until all the opposite cut edges have been collected; and
moving the collection box back to its original position.

In an embodiment of the present disclosure, after the collecting of all the opposite cut edges, the method further includes: obtaining the ingot without the cut edges, wherein the step of obtaining the ingot without the cut edges by the unloading mechanism includes: moving the unloading stage to a position directly located below the ingot;
raising the unloading stage to be in contact with a lower end surface of the ingot;
releasing the main hold shaft, so that the ingot is placed on the unloading stage; and
moving the ingot back to an original position of the unloading stage by the unloading stage.

The present disclosure provides a system for squaring an ingot, including: a squaring chamber configured to cut edges from the ingot; and a movement stage disposed at one side of the squaring chamber in a first direction, wherein the movement stage is provided with a loading mechanism and a unloading mechanism, the loading mechanism and the unloading mechanism are respectively arranged on two opposite sides of the movement stage in a second direction different from the first direction, and the loading mechanism is configured to transport another ingot to be squared to the squaring chamber while the unloading mechanism collects cut edges and removes the ingot after the edges are cut.

The present disclosure provides a method for squaring an ingot by using one of the above systems for squaring the ingot, wherein the method for squaring the ingot includes: sequentially cutting respective pairs of opposite cut edges in the squaring chamber, based on a number of the pairs of opposite cut edges of the ingot, and collecting the pairs of cut edges at a position between the squaring chamber and the movement stage after cutting the respective pairs of the opposite cut edges; and obtaining the ingot without the cut edges by the unloading mechanism, and at the same time, loading another ingot with the cut edges to be removed to the squaring chamber by the loading mechanism.

### BRIEF DESCRIPTION OF DRAWINGS

FIG. 1 is a top plan view of a system for controlling to square ingot according to an embodiment of the present disclosure;

FIG. 2 is a cross-sectional view of the preparation stage with the hold mechanism during loading according to an embodiment of the present disclosure;

FIG. 3 is a top plan view of the preparation stage with the ingot according to an embodiment of the present disclosure;

FIG. 4 is a cross-sectional view of the preparation stage with the ingot according to an embodiment of the present disclosure;

FIG. 5 is a cross-sectional view of the unloading stage with the ingot according to an embodiment of the present disclosure;

FIG. 6 is a top plan view of the collection box with the hold mechanism in the collecting process according to an embodiment of the present disclosure; and

FIG. 7 is a cross-sectional view of the unloading stage with the hold mechanism during unloading according to an embodiment of the present disclosure.

Reference signs illustrate:

| | |
|---|---|
| 10. | Squaring chamber |
| 20. | Hold mechanism |
| 21. | Main hold shaft |
| 22. | Auxiliary hold shaft |
| 23. | Suspension arm |
| 30. | Movement stage |
| 31. | Slide stage |
| 40. | Loading mechanism |
| 41. | Loading stage |
| 42. | preparation stage |
| 421. | Clamping member |
| 422. | Stopper |
| 423. | Pull bar |
| 43. | Loading track |
| 50. | Unloading mechanism |
| 51. | Unloading stage |
| 52. | Collection box |
| 53. | Unloading track |
| 54. | Baffle |
| 60. | Ingot |
| 61. | Squared bar |
| 62. | Cut edge |
| 424. | Rubber pad |
| 521. | Recession groove |

### DETAILED DESCRIPTION OF EMBODIMENTS

The present disclosure will be described in detail below with reference to the accompanying drawings and example embodiments.

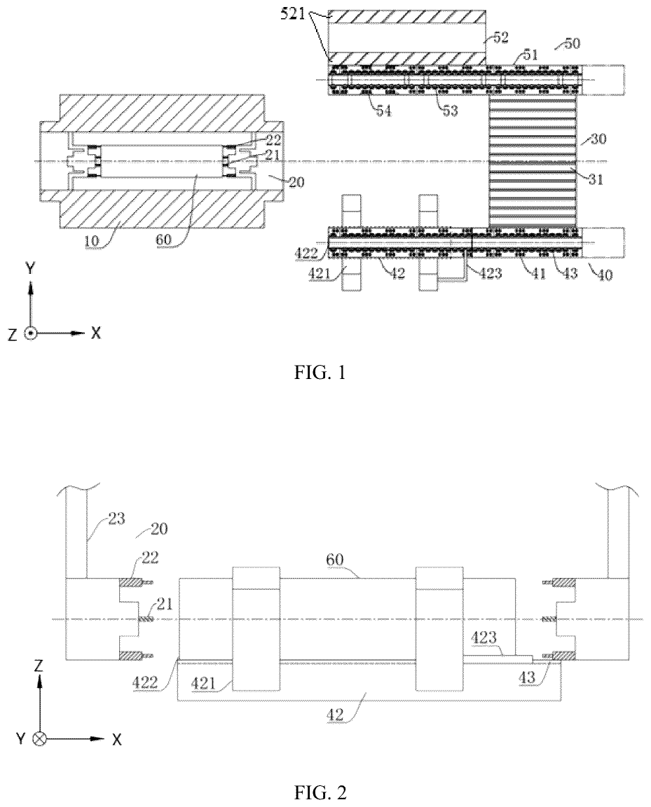

In the present embodiment, a system for squaring an ingot is provided. As shown in FIG. 1, the ingot squaring system may include a squaring chamber 10 for removing cut edges of the ingot 60 and a movement stage 30 disposed on one side of the squaring chamber 10. As used herein, the word “squaring” or its variability refers to cutting of silicon bars by rubbing silicon bar by the diamond wire at high speed to obtain a squared ingot.

In an embodiment, the ingot 60 including four crystal lines includes four cut edges 62 and a squared bar 61 (as shown in FIG. 6), but is not limited thereto. The ingot 60 may include six cut edges and a squared bar. Other configurations of the ingot 60 are well known for those skilled in the art, and thus are omitted in the accompanying drawings. The following is a description of an example of an ingot 60 including four crystal lines.

In an embodiment, the movement stage 30 may be spaced from the squaring chamber in a first direction X. That is, the movement stage 30 may be disposed on one side of the squaring chamber 10 in the first direction X. The first direction X may be a direction along which the squaring chamber 10 extends, i.e., a longitudinal direction of the squaring chamber 10.

On the movement stage 30, there are provided a loading mechanism 40 for transporting the ingot 60 with the cut edges to be removed to the squaring chamber 10, and a unloading mechanism 50 for removing the cut ingot 60 from the squaring chamber 10. The loading mechanism 40 and the unloading mechanism 50 may be respectively disposed on both sides of the movement stage 30. That is, the loading mechanism 40 and the unloading mechanism 50 may be disposed respectively on the both sides of the movement stage 30 opposite in a second direction Y different from the first direction X. While the unloading mechanism 50 removes the squared bar 61 (an ingot after removal of all the cut edges) and collects all the cut edges 62, the loading mechanism 40 may transport another ingot 60 with the cut edges to be removed to an entrance of the squaring chamber 10 close to the movement stage 30. In an embodiment, while the unloading mechanism 50 removes the squared bar 61 and collects the four cut edges 62, the loading mechanism 40 may transport another ingot 60 with the cut edges to be removed to an entrance of the squaring chamber 10 near the movement stage 30.

In an embodiment, the squaring chamber 10 may be a processing chamber enclosed by four side doors. Each of the side doors has a movable structure. The hold mechanism 20 may be provided in the processing chamber. The hold mechanisms 20 are suspended at both opposite sides of the ingot 60 in the first direction X, to hold ends of the ingot 60. As shown in FIG. 2, the hold mechanism 20 may include two sets of main hold shafts 21 and auxiliary hold shafts 22 suspended by the suspension arms 23 and respectively disposed at both opposite sides of the open chamber 10 in the first direction X. For each set of the main hold shafts 21 and the auxiliary hold shafts 22, the auxiliary hold shafts 22 may be disposed at opposite sides of the main hold shafts 21.

In an embodiment, each set of the main hold shafts 21 and the auxiliary hold shafts 22 may include two main hold shafts 21 and four auxiliary hold shafts 22. As shown in FIGS. 1 and 2, the two main hold shafts 21 may be arranged in the second direction Y, and the four auxiliary hold shafts 22 may include two auxiliary hold shafts 22 arranged in the second direction Y and two auxiliary hold shafts 22 arranged in another direction (e.g., a third direction) different from the first direction X and the second direction Y. In an embodiment, each set of the main hold shafts 21 and the auxiliary hold shafts 22 includes one main hold shaft 21 and two auxiliary hold shafts 22. In an embodiment, each set of the main hold shafts 21 and the auxiliary hold shafts 22 includes one main hold shaft 21 and four auxiliary hold shafts 22. Central axis of the main hold shafts 21 and a central axis of the squared bar 61 may be collinear, to hold opposite end surfaces of the squared bar 61. The auxiliary hold shafts 22 may be aligned with the cut edge 62 of the ingot 60, to hold opposing end surfaces of the cut edge 62 of the ingot 60. The main hold shaft 21 and the auxiliary hold shaft 22 may be controlled by two separate control systems, respectively. That is, the main hold shaft 21 and the auxiliary hold shaft 22 may be operated separately. As shown in FIG. 2, the main hold shaft 21 and the auxiliary hold shaft 22 may be moved together by the suspension arm 23 in the first direction X to the movement stage 30.

In holding the ingot 60, the main hold shafts 21 are the first to contact and fasten the end surfaces of the squared bar 61 of the ingot 60. After the main hold shafts 21 have been steadily held the squared bar 61, the auxiliary hold shafts 22 contact the end surfaces of any pair of the cut edges 62 provided at opposite sides of the squared bar 60, and are gradually fastened. After the pair of offcut edges 62 has been cut, the suspension arm 23 may move, to drive the movements of the main hold shaft 21, the auxiliary hold shaft 22 and the ingot 60 to a transition area between the squaring chamber 10 and the movement stage 30. The unloading mechanism 50 moves to directly below the ingot 60, all of the auxiliary hold shafts 22 at both sides of the ingot 60 in the first direction X are released, and the pair of cut edges 62 falls into the unloading mechanism 50. The unloading mechanism 50 stays still, and the suspension arm 23 moves, to drive the movement of the ingot 60 back to the squaring chamber 10, so that the other pair of cut edges 62 may be cutoff. After the ingot 60 is moved out of the squaring chamber 10 again, the other pair of cut edges 62 fall into the unloading mechanism 50. Then, the unloading mechanism 50 returns to the original position.

In an embodiment, both the loading mechanism 40 and the unloading mechanism 50 may extend parallel to the first direction X. In an embodiment, the loading mechanism 40 and the unloading mechanism 50 may be disposed perpendicular to the second direction Y. In an embodiment, the loading mechanism 40 and the unloading mechanism 50 are separately slidable in the second direction Y.

In an embodiment, the loading mechanism 40 may include a loading stage 41 disposed away from the squaring chamber 10 and secured at an end portion of the movement stage 30 in the second direction Y, and a preparation stage 42 disposed close to the squaring chamber 10 and cooperated with the loading stage 41. The loading stage 41 and the preparation stage 42 may extend in a first direction X and operate separately from each other. Loading tracks 43 of the same specification and structure and arranged coaxially are respectively disposed on the loading stage 41 and the preparation stage 42. Therefore, the ingot 60 moved onto the loading track 43 on the loading stage 41 may be moved from the loading stage 41 to the preparation stage 42 along the loading tracks 43. The load tracks 43 may extend in the first direction X.

In an embodiment, a height of the preparation stage 42 is constant. Accordingly, a height of the loading track 43 on the preparation stage 42 is constant. In other words, the preparation stage 42 may move in the first direction X and/or the second direction Y, but may not move up and down in the third direction Z. The loading stage 41 may move up and down in the third direction Z, but may not move in the first direction X and/or the second direction Y. To ensure that the ingot 60 is moved onto the preparation stage 42 through the loading stage 41, the height of the loading track 43 on the preparation stage 42 may be higher than that of an original position of the loading track 43 on the loading stage 41. The loading mechanism 40 may further include a loading turnover stage for transporting the ingot 60 with the offcut edges to be removed, and the loading turnover stage may be located on the side of the loading stage 41 away from the squaring chamber 10 and connected to the loading stage 41 (see the double dashed-line structure in FIG. 1). Considering a length of the loading turnover stage in the first direction X and the cost, the height of the loading turnover stage may not be so high that an original position of the loading stage 41 (e.g., a height of the original position) needs to be adapted to a height of the loading turnover stage (e.g., at the same level as the height of the loading turnover stage). Therefore, the height of the ingot 60 transported from the loading turnover stage is lower than an original position of the preparation stage 42 (e.g., the initial height). After the ingot 60 is moved from the loading turnover stage to the loading stage 41, the loading stage 41 may be automatically raised to the same height as the preparation stage 42, and the ingot 60 is transported to the preparation stage 42 through the loading track 43.

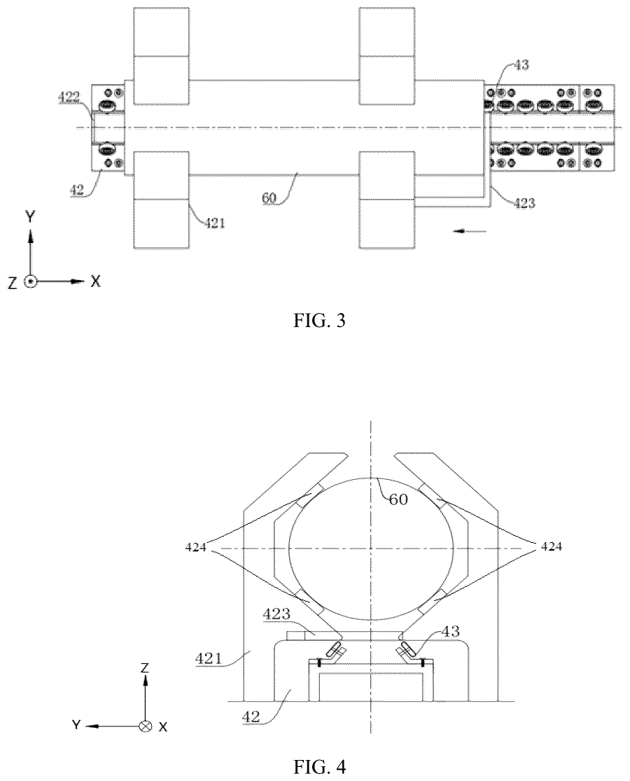

As shown in FIG. 3, two clamping members 421 are further disposed on the preparation stage 42. The clamping member 421 as robots grips the ingots 60. One of the two clamping members 421 disposed close to the squaring chamber 10 may be referred to as the first clamping member 421, and one of the two clamping members 421 disposed away from the squaring chamber may be referred to as the second clamping member 421.

As shown in FIG. 4, each clamping member 421 may include two opposite jaws disposed in the second direction Y and each jaw has a C-like shape inner sidewall. Upper and lower portions of each jaw are respectively disposed with rubber pads 424 protruding from an inner wall of the jaw toward a center of the ingot 60. The rubber pad 424 may be in direct contact with an outer wall surface of the ingot 60, to clamp the ingot 60. The loading track 43 disposed on the preparation stage 42 extend in a first direction X passing through a clamping areas defined by the opposed jaws. The loading track 43 includes a plurality of drum-like rubber rollers arranged in the first direction X. In an embodiment, the rubber rollers may be uniformly arranged along the first direction X, but are not limited thereto. In the cross-sectional view, all the rubber rollers are arranged obliquely upward and facing each other. That is, all the rubber rollers are arranged obliquely at an acute angle with respect to the second direction Y, and a pair of rubber rollers, which are arranged opposite to each other in the second direction Y, extend toward the ingot in a direction between the second direction Y and the third direction Z, so as to make point contact with an outer surface of the ingot 60. Sliding effect of the ingot 60 on the loading track 43 is improved and a sliding resistance of the ingot 60 on the loading track 43 is reduced.

As shown in FIG. 3, the loading track 43 on the preparation stage 42 may further include a stopper 422 for positioning the ingot 60. The stopper 422 may be secured at an end of the load track 43 on the preparation stage 42 close to the squaring chamber 10. The stopper 422 is disposed to position the ingot 60 at a position where the ingot 60 is to be clamped with the hold mechanism 20, so that the hold mechanism 20 accurately holds the ingot 60.

In an embodiment, the first clamping member 421 close to the stopper 422 may move in the second direction Y, but not in the first direction X, in order to position a clamped position for the ingot 60 close to the stopper 422.

In an embodiment, a pull bar 423 of an L-shaped configuration is disposed on one of the second clamping members 421 away from the stopper 422. One end of the pull bar 423 is secured to a side surface of the one of the second clamping members 421 close to the loading stage 41. The other end of the pull bar 423 is suspended. The pull bar 423 extends from the one end of the pull bar 423 in a first direction X toward the loading stage, and then extends in the second direction Y to the other end of the pull bar 423 toward the loading stage 50. The second clamping member 421 is moved in the first direction X and the second direction Y. That is, the second clamping member 421 may be tightened or expanded in the second direction Y in synchronization with the first clamping member 421, to clamp or release the ingot 60. In addition, different from the first clamping member 421, the second clamping member 421 is further moved in the second direction Y, such that the second clamping member 421 pulls the ingot 60 to move along the load track 43 toward the stopper 422 by the pull bar 423, until the ingot 60 is abutted against and secured to the preparation stage 42 by the stopper 422. After the ingot 60 is secured, the second clamping member 421 returns to its original position. The first clamping member 421 and the second clamping member 421 are tightened simultaneously to clamp the ingot 60, and make the ingot 60 move linearly along a straight line where the central axis of the squared bar 61 is located (that is, toward a door of the squaring chamber 10), and meet with the hold mechanism 20 waiting in advance at a space between the squaring chamber and the movement stage 30, as shown in FIG. 2. The original position of the second clamping member 421 and a secured position of the first clamping member 421 are arranged symmetrically with respect to a centerline of a length of the ingot 60, so as to ensure the balance of the ingot 60 during being clamped.

As shown in FIG. 1, the unloading mechanism 50 is disposed at the end of the movement stage 30 away from the loading mechanism 40 in the second direction Y. In an embodiment, the unloading mechanism 50 and the loading mechanism 40 may be symmetrically disposed on both sides of the movement stage 30 in the second direction Y. The unloading mechanism 50 includes a unloading stage 51 partially secured to the movement stage and a collection box 52 for collecting the cut edges 62. The unloading stage 51 may be located above the collection box 52 in the third direction Z, and both the unloading stage 51 and the collection box 52 may be operated separately. The unloading stage 51 may be moved up and down in the third direction Z, or may be moved in the second direction Y, but may not be moved in the first direction X. The unloading stage 51 may be vertically moved up and down in the third direction Z, to receive the squared bar 61 and move it to an unloading turnover stage (a double dashed-line structure in FIG. 1). The unloading turnover stage may be connected to the unloading stage 51.

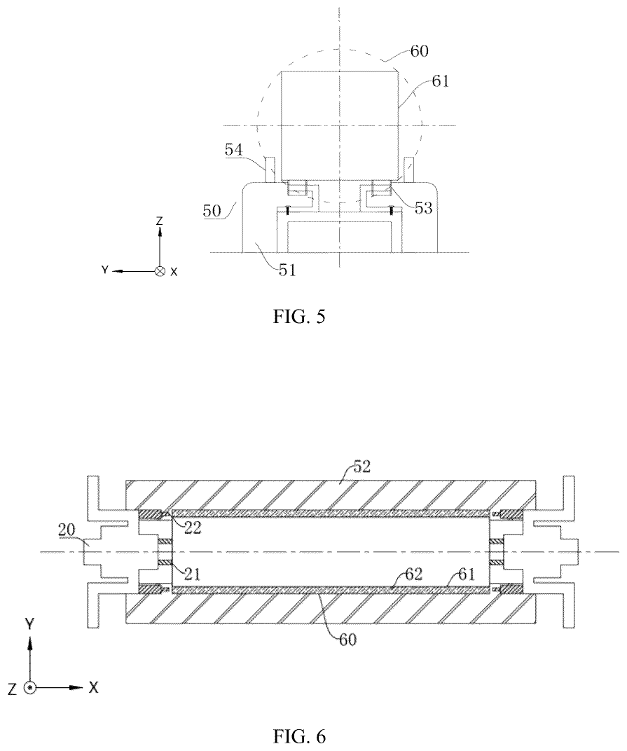

A unloading track 53 may be disposed on the unloading stage 51. The unloading track 53 has same shape, structure and material as the loading track 43. The unloading track 53 may also include a plurality of rubber rollers arranged in the first direction X. In an embodiment, the rubber roller may have a cylindrical-like configuration. In an embodiment, the rubber rollers may be uniformly arranged along the first direction X, but are not limited thereto. In the cross-section view, the rubber rollers are horizontally arranged, that is, an upper surface and a lower surface of each of the rubber rollers may be parallel to a plane defined by the first direction X and the second direction Y. The unloading track 53 may be configured to carry a squared bar 61. In order to ensure the stability of the squared bar 61 on the unloading track 53, all the rubber rollers on the unloading track 53 are arranged horizontally, and cooperation of the squared bar 61 with the unloading track 53 is shown in FIG. 5.

In order to ensure the accuracy of a position of the squared bar 61 on the unloading track 53, a plurality of sets of baffles 54 for preventing the squared bar 61 from shifting are disposed at least on an end portion of the unloading track 53 in the first direction X close to the squaring chamber 10. The baffles 54 may be arranged spaced apart from each other in the first direction X, and the baffles 54 may be arranged on both sides of the unloading track 53. The baffles 54 disposed on the both sides of the unloading track 53 may face each other in the second direction Y, or may be disposed in a staggered manner, so long as the purpose of preventing the squared bar 61 from shifting may be achieved.

In an embodiment, as shown in FIG. 1, the movement stage 30 further includes a slide stage 31 disposed outside the squaring chamber 10. The slide stage 31 may extend in the second direction Y. In an embodiment, the second direction Y may be perpendicular to the first direction X. The slide stage 31 may be arranged symmetrically with respect to a linear axis in which the central axis of the squared bar 61 is located.

As shown in FIGS. 1 and 6, a length of the unloading stage 51 may be not less than a length of the collection box 52, and the length of the unloading stage 51 may be substantially the same as the sum of the lengths of the loading stage 41 and the preparation stage 42. The two recession grooves 521 may extend in parallel in the first direction X and are respectively disposed at opposite sides of the collection box 52 in the second direction Y. A distance between the recession grooves 521 is not greater than a width of the squared bar 61. During the collection of any set of falling cut edges 62 disposed opposite to each other, the collection box 52 may be moved to a position immediately below the ingot 60 outside the squaring chamber 10, and the two recession grooves 521 of the collection box 52 may be disposed symmetrically with respect to a length axis of the ingot 60. The cut edges 62 on both sides of the ingot 60 may fall into the two recession grooves 521, respectively. The collection box 52 is kept at the above-mentioned position for collecting the cut edges 62, until the two sets of cut edges 62 of the ingot 60 are completely collected by the recession grooves 521. The collection box 52 carrying the cut edge 62 is moved back to its original position, i.e., an end portion of the slide stage 31 away from the loading stage 41.

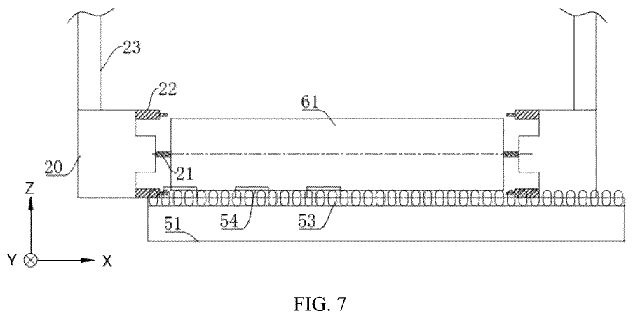

As shown in FIG. 7, while the collection box 52 is retracted, the unloading stage 51 is moved by an external force toward the position where the squared bar 61 is located, that is, toward the space between the squaring chamber 10 and the slide stage 31, until the unloading track 53 is moved to a location directly below the squared bar 61. The unloading stage 51 is vertically moved upward in the third direction Z, until the rubber rollers on the unloading track 53 is fully in contact with the squared bar 61, and the squared bar 61 is released by the hold mechanism 20. The hold mechanism 20 may be held in place after releasing the squared bar 61, and wait for another ingot 60 with cut edges to be moved. The unloading stage 51 carrying the squared bar 61 moves downwards in the third direction Z to its initial height, and moves in the second direction Y back to a position coaxial with the unloading turnover stage. The unloading of the squared bar 61 is completed.

While the unloading stage 51 carrying the squared bar 61 is retracted, another ingot 60 with cut edges to be removed on the preparation stage 42 is clamped by the two clamping members 421 and gradually moved to a position where the hold mechanism 20 is located. The end surfaces of the squared bar 61 in the ingot 60 are hold by the main hold shafts 21 in the hold mechanism 20. The end surfaces of any set of opposite cut edges 62 of the ingot 60 are hold by the auxiliary hold shaft 22. The clamping members 421 unclamps the jaws, to release the ingot 60. The clamping member 421 is kept in position. The hold mechanism 20 is driven, so that the suspension arm 23 drives the main hold shafts 21 and the auxiliary hold shafts 22 holding the ingot 60 to move into the squaring chamber 10 along the first direction X. After the hold mechanism 20 carrying the ingot 60 moves into the squaring chamber 10, the four side door of the squaring chamber 10 is closed, to perform a cutting and edge-removing operation. The clamping members 421 of the preparation stage 42 remain expanded, and the empty preparation stage 42 returns to its original position, and waits for another ingot 60 with the cut edges to be removed.

A method for squaring the ingot is performed by using a system according to any of the above embodiments. The method includes the steps of:
sequentially cutting respective pairs of opposite cut edges 62 in the squaring chamber 10, based on a number of pairs of opposite cut edges 62 of the ingot 60, and collecting the pairs of cut edges 62 at a position between the squaring chamber 10 and the movement stage 30 after cutting the respective pairs of the opposite cut edges 62; and
obtaining the squared bar 61 without the cut edges by the unloading mechanism 50, and at the same time, loading another ingot 60 with cut edges to be removed at the door of the squaring chamber 10 close to the movement stage 30 by the loading mechanism 40.

In an embodiment, the method further includes, before the loading of another ingot 60 with cut edges to be removed at the door of the squaring chamber 10 close to the movement stage 30 by the loading mechanism 40, securing the ingot 60 on the preparation stage 42 of the loading mechanism 40. The securing of the ingot 60 on the preparation stage 42 of the loading mechanism 40 includes:
transporting the ingot onto the preparation stage along the loading tracks from the loading stage of the loading mechanism; and
moving the ingot towards one end of the preparation stage close to the squaring chamber by one of the second clamping members of the preparation stage close to the loading stage.

In an embodiment, the transporting of the ingot onto the preparation stage along the loading tracks from the loading stage of the loading mechanism includes:
transporting the ingot 60 from the loading turnover stage to the loading stage 41;
automatically raising the loading stage 41 to the same height as the preparation stage 42; and
moving the ingot 60 from the loading stage 41 to the preparation stage 42 along the loading tracks 43. At this time, both of the clamping members 421 of the preparation stage 42 are in an expanded state. Accordingly, the loading stage 41 falls up to its original height position and is ready to receive another ingot 60 transported from the loading turnover stage.

In an embodiment, the method may further include: moving the two jaws of the second clamping member 421 close to the loading stage 41 toward each other in the second direction Y, after the ingot 60 is completely transferred onto the preparation stage 42, so that the second clamping member 421 has a reduced width in the second direction and does not contact the outer surface of the ingot 60, and the pull bar 423 disposed on the second clamping member 421 directly faces the end surface of the ingot 60 close to the loading stage 41;
driving the pull bar 423 to contact with the end surface of the ingot 60 by the second clamping member 421 close to the loading stage 41, and pulling the ingot 60 by the pull bar 423 along the loading tracks 43 to move toward the squaring chamber 10, until the end surface of the ingot 60 away from the loading stage 41 abuts against the stopper 422 on the loading track 43 of the preparation stage 42, so that the ingot 60 is positioned on the preparation stage 42;
moving the second clamping member 421 close to the loading stage 41 toward the loading stage 41, until it is positioned symmetrically with the first clamping member 421 with respect to the midline of the length of the ingot 60, so that all of the clamping members 421 (e.g., the first clamping member and the second clamping member) contract and clamp the ingot 60;
moving the ingot 60 by the preparation stage 42 in the second direction Y to the door of the squaring chamber 10 close to the slide stage 31, that is, to the area formed by the opposite main hold shafts 21 and auxiliary hold shafts 22 moved in advance between the squaring chamber 10 and the slide bar 31.

In an embodiment, the method further includes: before loading other ingot 60 with cut edges to be removed at the door of the squaring chamber 10 close to the movement stage by the loading mechanism 40, clamping the ingot 60 by the hold mechanism 20 including:
moving the hold mechanism 20 in advance between the squaring chamber 10 and the slide stage 31, and making the two sets of the main hold shafts 21 and the auxiliary hold shafts 22 be opposed to each other in the first direction X and be suspended at both ends of the ingot 60. The suspension arm 23 drives the main hold shafts 21 and the auxiliary hold shafts 22 to move to a position coaxial with the ingot 60;
first securing the end surfaces of a preset squared bar 61 in the ingot 60 by the main hold shafts 21; securing the end surfaces of any pair of the opposing cut edges 62 of the ingots 60 by the auxiliary hold shaft 22;
fully clamping both ends of the ingot 60 by the hold mechanism 20, and slowly moving the jaws of the clamping members 421 of the preparation stage 42 outwardly, to release the ingot 60;
moving the ingot 60 by the hold mechanism 20 passing through a space between the clamping members 421 and into the squaring chamber 10, to be cut. At the same time, the preparation stage 42 is moved in its entirety in the second direction Y back to its original position, and wait for the loading of another ingot 60.

In an embodiment, the obtaining of the squared bar 61 without a cut edge through the unloading mechanism 50 includes: collecting the cut edges 62 by the collection box 52, and the collecting of the cut edges 62 by the collection box 52 includes:
after the cut edge 62 is cut, moving the ingot 60 to a location out of the squaring chamber 10 by the hold mechanism 20 and moved to a position where the ingot 60 is camped, i.e., between the squaring chamber 10 and the slide stage 31;
moving the collection box 52 from a position below the unloading stage 51 to a position directly below the ingot 60 which is taken out of the squaring chamber 10, and moving the two recession grooves 521 of the collection box 52 to be respectively located on both sides of the central axis of the ingot 60;
synchronously releasing the auxiliary hold shafts 22 and synchronously dropping the opposite cut edges 62 into the corresponding recession grooves 521, wherein the collection box 52 is secured in this position;
repeating the above steps until the collection of the other pair of opposite cut edges 62 is completed and moving the collection box 52 back to its original position.

In an embodiment of the present disclosure, the obtaining of the squared bar 61 without the cut edges by the unloading mechanism 50 further includes: receiving the squared bar 61 without the cut edges, after all of the cut edges are collected. The receiving of the squared bar 61 without the cut edges includes:
moving the unloading stage 51 to directly located below the squared bar 61 in the second direction Y;
raising the unloading stage 51 in the third direction Z until it comes into contact with a lower end surface of the squared bar 61; and
releasing the main hold shafts 21, so that the squared bar 61 is placed on the unloading track 53 on the unloading stage 51, lowering the unloading stage 51 to its initial height, after the squared bar 61 is placed stably, and moving the squared bar 61 back to the original position of the unloading stage 51.

At this time, another ingot 60, which has been placed on the preparation stage 42, is moved directly below the hold mechanism 20.

Table 1 shows a comparison the time taken of the loading, the squaring, the collecting of the cut edges 62, and the unloading, as well as apparatus activation of any ingot 60 by using any of the above methods, as compared to the related art. From Table 1, the squaring time for each ingot was reduced to 18-22 min, and the apparatus activation was increased to 95-97%.

TABLE 1
Technical effects obtained by the presented method and the related art

| | Processing time/min | Apparatus Activation/% |
|---|---|---|
| Presented method | 17-22 | 95-97 |
| Related art | 25-30 | 90-93 |

In comparison with the related art, in an embodiment of the present disclosure, the unloading of the ingots to be squared and the unloading of the ingots without the cut edges are carried out on different sides. The unloading of the ingots with the cut edges having been removed during a previous cycle and the loading of the ingots to be squared in a next cycle may be carried out synchronously. Therefore, the safety of the silicon bars may be improved. In addition, the unloading and the unloading of the ingots may be carried out smoothly. The production efficiency is high, the overall processing time is shortened to 18-22 min, and the apparatus activation is increased to 95-97%. By using the structure with the separate loading and unloading, the bump between the cut edges and between the cut edges and the crystal bar may be improved, and the quality of the silicon bar may be improved. The present disclosure provides a system and a method for controlling the squaring for an ingot, which solve the technical problems in the related art that the production efficiency is low and the serious bump of the silicon bar due to the loading of the ingot and the unloading of the squared bar on the same side.

Embodiments of the present disclosure have been described in detail above and are merely preferred embodiments of the present disclosure and are not to be considered as limiting the scope of the present disclosure. All equivalents and modifications made in accordance with the present disclosure shall fall within the scope of the present disclosure.

1. A system for squaring an ingot, comprising:
a squaring chamber configured to cut edges from the ingot; and
a movement stage disposed at one side of the squaring chamber in a first direction,
wherein the movement stage is provided with a loading mechanism and an unloading mechanism, the loading mechanism and the unloading mechanism are respectively arranged on two opposite sides of the movement stage in a second direction different from the first direction, and the loading mechanism is configured to transport an ingot to be squared to the squaring chamber while the unloading mechanism collects cut edges and removes the ingot after the edges are cut.

2. The system for squaring the ingot of claim 1, wherein the squaring chamber comprises a hold mechanism suspended in the first direction for holding the ingot, and the hold mechanism comprises main hold shafts and auxiliary hold shafts;
the main hold shafts are configured to hold end surfaces of the ingot;
the auxiliary hold shafts are configured to hold opposite end surfaces of the cut edges of the ingot; and
the main hold shafts and the auxiliary hold shafts are configured to move together to the movement stage in the first direction.

3. The system for squaring the ingot of claim 2, wherein the loading mechanism comprises:
a loading stage secured at an end portion of the movement stage in the second direction; and
a preparation stage disposed close to the squaring chamber and cooperated with the loading stage,
wherein the loading stage and the preparation stage are provided with loading tracks arranged coaxially;
the preparation stage is further provided with two clamping members for grasping the ingot; and
a height of the loading track of the preparation stage is constant and higher than a height of an original position of the loading track of the loading stage, and the loading stage is configured to move up and down in a vertical direction, so that the ingot disposed on the loading stage moves onto the preparation stage along the loading track.

4. The system for squaring the ingot of claim 3, wherein each of the clamping members comprises two jaws disposed opposite to each other in the second direction, each jaw has a C-like shaped inner sidewall, and the loading track of the preparation stage extends in the first direction passing through a clamping area defined by the jaws.

5. The system for squaring the ingot of claim 3, wherein the loading track on the preparation stage comprises a stopper for positioning the ingot, and the stopper is secured at an end of the loading track on the preparation stage close to the squaring chamber;
one of the clamping members close to the stopper is configured to move in the second direction; and
one of the clamping members away from the stopper is configured to move in the first direction and the second direction.

6. The system for squaring the ingot of claim 5, wherein a pull bar is disposed on the one of the clamping members away from the stopper, and the pull bar is driven by the one of the clamping members away from the stopper to pull the ingot to move toward the stopper and to make the ingot being abutted against and secured onto the preparation stage by the stopper, and
the pull bar has an L-shaped configuration, one end of the pull bar is secured to a side surface close the loading stage of the one of the second clamping members away from the stopper, and another end of the pull bar is suspended.

7. The system for squaring the ingot of claim 3, wherein the unloading mechanism is disposed at an end portion of the movement stage away from the loading mechanism, the unloading mechanism comprises an unloading stage partially secured to the movement stage and a collection box for collecting the cut edges;
the unloading stage is located above the collection box in a third direction different from the first direction and the second direction, and operates independently from the collection box; and
the unloading stage is configured to move up and down in the third direction to receive the ingot without the cut edges and to move the ingot to an unloading turnover stage.

8. The system for squaring the ingot of claim 7, wherein the unloading stage is disposed with an unloading track;
both the unloading track and the loading track comprise a plurality of rubber rollers;
the rubber rollers of the unloading tracks are all horizontally arranged;
the rubber rollers of the loading tracks are all arranged obliquely upward and facing each other; and
an end portion of the unloading track close the squaring chamber is provided with a plurality of sets of baffles for preventing the ingot without the cut edges from shifting, and the baffles are arranged spaced apart from each other in the first direction and are disposed on both sides of the unloading track.

9. The system for squaring the ingot of claim 8, wherein the collection box comprises two recession grooves, the recession grooves extend in parallel in the first direction and are respectively disposed at two opposite sides of the collection box in the second direction, and a distance between the recession grooves is not greater than a width of the ingot without the cut edges; and
the collection box is configured to move to a location directly below the ingot and outside the squaring chamber cut edge with the two recession grooves symmetrically disposed with respect to a central axis of the ingot before each pair of opposite cut edges falls.

10. The system for squaring the ingot of claim 1, wherein
the movement stage comprises a slide stage disposed outside the squaring chamber, the loading mechanism and the unloading mechanism are both disposed parallel to the first direction and perpendicular to the second direction, and the loading mechanism and the unloading mechanism are separately slidably disposed along the second direction.

11. A method for squaring an ingot by using the system for squaring the ingot of claim 6, wherein the method for squaring the ingot comprises:
sequentially cutting respective pairs of opposite cut edges in the squaring chamber, based on a number of the pairs of the opposite cut edges of the ingot, and collecting the pairs of cut edges at a position between the squaring chamber and the movement stage after cutting the respective pairs of the opposite cut edges; and
obtaining the ingot without the cut edges by the unloading mechanism, and at the same time, loading another ingot with cut edges to be removed to the squaring chamber by the loading mechanism.

12. The method for squaring the ingot of claim 11, wherein the method further comprises: before the step of loading another ingot with the cut edges to be removed at the door of the squaring chamber close to the movement stage by the loading mechanism, securing the ingot on the preparation stage of the loading mechanism, wherein the step of securing the ingot on the preparation stage of the loading mechanism comprises:
transporting the ingot onto the preparation stage along the loading tracks from the loading stage of the loading mechanism;
moving the ingot towards one end of the preparation stage close to the squaring chamber by one of the clamping members on the preparation stage close to the loading stage;
making the end surface of the ingot away from the loading stage abut the stopper on the loading track of the preparation stage;
clamping the ingot by all the clamping members; and
moving the ingot by the preparation stage to the door of the squaring chamber close to the slide stage.

13. The method for squaring the ingot of claim 12, wherein the step of clamping the ingot by all the clamping members comprises:
suspending the hold mechanism at the position between the squaring chamber and the movement stage, and providing in advance the hold mechanism at both ends of the ingot;
securing the end surfaces of the ingot by the main hold shaft;
securing the end surfaces of any pair of opposite cut edges of the ingot by the auxiliary hold shaft;
moving the ingot by the hold mechanism passing through a space between the clamping members and into the squaring chamber to be cut; and
moving the preparation stage to retract opened clamping members.

14. The method for squaring the ingot of claim 12,
wherein the unloading mechanism comprises an unloading stage partially secured to the movement stage and a collection box for collecting the cut edges; and
wherein the step of collecting the pairs of cut edges at the position between the squaring chamber and the movement stage comprises:
moving the collection box from a position below the unloading stage to a position directly below the ingot taken out of the squaring chamber;
releasing the auxiliary hold shafts and dropping the opposite cut edges to fall into the recession grooves of the collection box corresponding to the cut edges respectively;
repeating the above steps until all the opposite cut edges have been collected; and
moving the collection box back to its original position.

15. The method for squaring the ingot of claim 14, wherein the step of obtaining the ingot without the cut edges by the unloading mechanism comprises:
moving the unloading stage to a position directly located below the ingot;
raising the unloading stage to be in contact with a lower end surface of the ingot;
releasing the main hold shaft, so that the ingot is placed on the unloading stage; and
moving the ingot back to an original position of the unloading stage by the unloading stage.

16. The system for squaring the ingot of claim 2, wherein the movement stage comprises a slide stage disposed outside the squaring chamber, the loading mechanism and the unloading mechanism are both disposed parallel to the first direction and perpendicular to the second direction, and the loading mechanism and the unloading mechanism are separately slidably disposed along the second direction.

17. The method for squaring the ingot of claim 13, wherein the unloading mechanism comprises an unloading stage partially secured to the movement stage and a collection box for collecting the cut edges; and
wherein the step of collecting the pairs of cut edges at the position between the squaring chamber and the movement stage comprises:
moving the collection box from a position below the unloading stage to a position directly below the ingot taken out of the squaring chamber;
releasing the auxiliary hold shafts and dropping the opposite cut edges to fall into the recession grooves of the collection box corresponding to the cut edges respectively;
repeating the above steps until all the opposite cut edges have been collected; and
moving the collection box back to its original position.

18. The method for squaring the ingot of claim 17, wherein the step of obtaining the ingot without the cut edges by the unloading mechanism comprises:
moving the unloading stage to a position directly located below the ingot;
raising the unloading stage to be in contact with a lower end surface of the ingot;
releasing the main hold shaft, so that the ingot is placed on the unloading stage; and
moving the ingot back to an original position of the unloading stage by the unloading stage.
